(19) United States
(12) Patent Application Publication
(10) Pub. No.: US 2017/0261774 A1
(43) Pub. Date: Sep. 14, 2017

(54) LIGHT CURING DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Guowei CHEN, Beijing (CN); Ning TIAN, Beijing (CN); Chengchao LI, Beijing (CN); Wenjun JI, Beijing (CN)

(21) Appl. No.: 15/223,289

(22) Filed: Jul. 29, 2016

(30) Foreign Application Priority Data
Mar. 10, 2016 (CN) 201610136663.5

(51) Int. Cl. G02F 1/13; B65G 15/42

(52) U.S. Cl. CPC G02F 1/1303; B65G 15/42

(57) ABSTRACT

A light curing device comprises a conveyor belt and a light source provided above the conveyor belt. A positioning block is provided on at least a portion, which is parallel to a conveying direction of the conveyor belt, of a carrying surface of the conveyor belt, and the positioning block includes a positioning surface which is perpendicular to the carrying surface of the conveyor belt and extends along the conveying direction of the conveyor belt. The positioning surface is configured to position an object to be conveyed.

### CROSS-REFERENCE TO RELATED APPLICATIONS

The present application claims the priority of Chinese Patent Application No. 201610136663.5, filed on Mar. 10, 2016, the contents of which are incorporated herein in their entirety by reference.

### TECHNICAL FIELD

The present invention relates to the field of display technology, and in particular, relates to a light curing device.

### BACKGROUND

During manufacture of a liquid crystal display panel, some film layers in the liquid crystal display panel need to be cured by irridating light thereon. Nowadays, a light curing device for curing a film layer by irridating light thereon includes an automatic light curing device and a semi-automatic light curing device. Since the automatic light curing device is expensive, the semi-automatic light curing device accounts for a larger share in the market.

A commonly used light curing device is a semi-automatic light curing device as shown in FIGS. 1 and 2. FIG. 1 is a top view showing an existing light curing device, and FIG. 2 is a front view showing the light curing device of FIG. 1. The light curing device includes a conveyor belt 1, a positioning baffle 2 provided above the conveyor belt 1, a baffle support 3 and an ultraviolet irradiation lamp 4. The baffle support 3 is configured to fix the positioning baffle 2 above the conveyor belt 1. The positioning baffle 2 is configured to provide positioning support to a liquid crystal display panel 5 conveyed on the conveyor belt 1, so that the liquid crystal display panel 5 can be positioned on the conveyor belt 1, and the ultraviolet irradiation lamp 4 can irradiate light on a film layer in the liquid crystal display panel 5 to make the film layer cured.

The inventors of the present invention found at least the following disadvantages existing in the prior art.

It is difficult to adjust a position of the positioning baffle 2, and the positioning accuracy thereof is low, making it difficult to deal with liquid crystal display panels 5 with different sizes. For example, in a case where a position of the positioning baffle 2 is too high, positioning effect of a liquid crystal display panel 5 on the conveyor belt 1 is poor and the liquid crystal display panel 5 is easy to shift. In a case where a position of the positioning baffle 2 is too low, the positioning baffle 2 may crush a liquid crystal display panel 5, and even causes the conveyor belt 1 to be stuck, which may cause overload of or damage to a driving motor.

Therefore, it is a technical problem to be solved urgently to design a light curing device which has a good positioning effect and a simple structure and can be adjusted easily and applied to dealing with liquid crystal display panels with different sizes.

### SUMMARY

In view of the above disadvantages existing in the prior art, the present invention provides a light curing device, which has a good positioning effect and a simple structure and can be adjusted easily and applied to dealing with objects, such as liquid crystal display panels, with different sizes.

Embodiments of the present invention provide a light curing device, including a conveyor belt and a light source provided above the conveyor belt, wherein, a positioning block is provided on at least a portion, which is parallel to a conveying direction of the conveyor belt, of a carrying surface of the conveyor belt, the positioning block includes a positioning surface which is perpendicular to the carrying surface of the conveyor belt and extends along the conveying direction of the conveyor belt, and the positioning surface is configured to position an object to be conveyed.

Optionally, the positioning block includes a plurality of positioning sub-blocks which are strip-shaped, the plurality of positioning sub-blocks are arranged parallel to each other in the conveying direction of the conveyor belt, and respective side surfaces of the plurality of positioning sub-blocks which face towards a same direction form the positioning surface.

Optionally, the positioning block is an elongated integral structure extending in the conveying direction of the conveyor belt, and the positioning surface is a side surface of the elongated integral structure.

Optionally, the light curing device further includes a support unit including a slide rail and a rail support, wherein, the rail support is configured to support the slide rail, the slide rail is provided horizontally above the conveyor belt so that a lengthwise direction of the slide rail is perpendicular to the conveying direction of the conveyor belt, and the light source is provided on the slide rail and is moveable along the slide rail.

Optionally, the rail support is an extensible and retractable support, a length and/or a height of which are adjustable, and is provided at one or two sides of the conveyor belt.

Optionally, the slide rail and/or the extensible and retractable support include scale marks, which are configured as a reference for adjusting a position of the light source.

Optionally, a fastening knob is provided on the slide rail and is connected to the light source, the fastening knob is capable of being tightened so that the light source is fixed to the slide rail and being loosened so that the light source is moveable along the slide rail.

Optionally, the light source is an ultraviolet light source.

Optionally, the light source is capable of moving in a direction perpendicular to the conveying direction of the conveyor belt.

Optionally, both the conveyor belt and the positioning block are made of an antistatic material.

Optionally, the positioning surface is a plane and is configured to closely contact a surface of an object to be conveyed.

In the light curing device provided by the present invention, on one hand, a positioning block is provided on at least a portion of a carrying surface of the conveyor belt and the positioning block includes a positioning surface which is configured to position an object to be conveyed. As a result, the light curing device has a simple structure and a good positioning effect, and avoids the disadvantages due to employing a positioning baffle in the prior art. On the other hand, the light source is provided on the slide rail which is supported by the extensible and retractable support, such that the light source can move both horizontally and vertically relative to the conveyor belt. As a result, a position of the light source can be controlled conveniently and accurately, enabling the light curing device to deal with objects, such as liquid crystal display panels, with different sizes.

### BRIEF DESCRIPTION OF THE DRAWINGS

FIG. 1 is a top view showing an existing light curing device;

FIG. 2 is a front view showing the light curing device of FIG. 1;

FIG. 3 is a top view showing a light curing device according to an embodiment of the present invention; and

FIG. 4 is a front view showing the light curing device of FIG. 3.

### DETAILED DESCRIPTION

To enable those skilled in the art to better understand the technical solutions of the present invention, the present invention will be further described in detail below in conjunction with the accompanying drawings and specific embodiments.

An embodiment of the present invention provides a light curing device. The light curing device includes a conveyor belt 10 and a positioning block 12 provided on a carrying surface of the conveyor belt 10. The positioning block 12 includes a positioning surface 120, which is configured to position an object to be conveyed. In the field of manufacturing and processing a liquid crystal display panel, an object to be conveyed may be a liquid crystal display panel 5, but the present invention is not limited thereto. For example, in another field of manufacture and process, an object to be conveyed is a corresponding object to be processed. The light curing device may further include a rail support 14, a slide rail 13, and a light source 11. The rail support 14 may be an extensible and retractable support. The rail support 14, which is extensible and retractable, is configured to support the slide rail 13, and the light source 11 is provided on the slide rail 13 so that the light source 11 can move in both a horizontal direction and a vertical direction. The light curing device is applicable to processing objects, such as liquid crystal display panels, with different sizes. It should be noted that, the light curing device is applicable to processing any object including a film layer which can be cured by light irradiation.

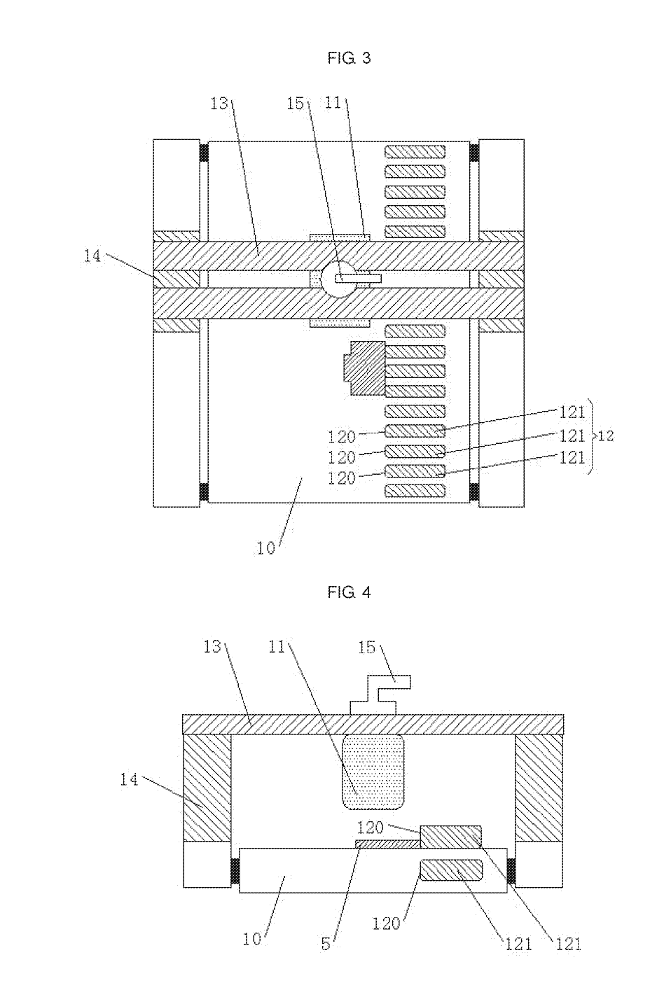

The light curing device will be described in more detail below. FIG. 3 is a top view showing the light curing device, and FIG. 4 is a front view showing the light curing device of FIG. 3. As shown in FIGS. 3 and 4, the light curing device includes the conveyor belt 10 and the light source 11 provided above the conveyor belt 10. The positioning block 12 is provided on at least a portion, which is parallel to a conveying direction of the conveyor belt 10, of a carrying surface of the conveyor belt 10. The positioning block 12 includes the positioning surface 120 which is perpendicular to the carrying surface of the conveyor belt 10 and extends along the conveying direction of the conveyor belt 10, and the positioning surface 120 is configured to position an object to be conveyed.

In the present embodiment, the light source 11 may be an ultraviolet light source, and can move horizontally and vertically in a direction perpendicular to the conveying direction of the conveyor belt 10. For example, the light source 11 can move in a horizontal direction along the slide rail 13, and can move in a vertical direction when a height of the rail support 14, which will be described later, is adjusted. The positioning block 12 may include a plurality of positioning sub-blocks 121 which are strip-shaped. The plurality of positioning sub-blocks 121 are arranged parallel to each other in the conveying direction of the conveyor belt 10, and respective side surfaces, which face towards a same direction, of the plurality of positioning sub-blocks 121 form the positioning surface 120. As shown in FIGS. 3 and 4, the plurality of positioning sub-blocks 121 are provided on a portion of the carrying surface of the conveyor belt 10 proximal to a right side thereof, and the positioning surface 120 is formed by left side surfaces of the plurality of positioning sub-blocks 121 and is a plane. The positioning surface 120 can be in close contact with a surface of a liquid crystal display panel 5 being conveyed. Thus, the light curing device can position an object being conveyed, and prevent the object being conveyed from randomly changing its position on the conveyor belt 10, facilitating the light source 11 to irradiate light on a film layer in the object being conveyed so as to make the film layer cured.

For example, in the field of display technology, in a case where the light curing device is applied to processing a liquid crystal display panel 5 being conveyed, to ensure the conveyor belt 10 and the positioning block 12 to apply a greater frictional force onto the liquid crystal display panel 5 being conveyed while not degrading the performance of the liquid crystal display panel 5 being conveyed, both the conveyor belt 10 and the positioning block 12 may be made of an antistatic material. As an example, the positioning block 12 may be made of an antistatic plastic, such that the positioning block 12 can apply a greater frictional force onto the liquid crystal display panel 5 being conveyed, and have a better extensibility and flexibility.

Alternatively, the positioning block 12 may be an elongated integral structure extending in the conveying direction of the conveyor belt 10. In this case, the positioning surface 120 is a side surface of the elongated integral structure, for example, is the left side surface of the positioning block 12 as shown in FIGS. 3 and 4. The positioning surface 120 may be a plane and configured to closely contact a surface of an object to be conveyed by the conveyor belt 10. A shape of another side surface of the positioning block 12 which does not form a positioning surface is not limited, and said another side surface may be a plane, a curved surface, or a surface with irregular protrusions and/or recesses. For the comparison between the positioning block including a plurality of positioning sub-blocks which are strip-shaped and the positioning block which is an elongated integral structure, the positioning block which is an elongated integral structure has advantages of simpler structure and easier to be manufactured, while the positioning block including a plurality of positioning sub-blocks which are strip-shaped has advantages of better extensibility and flexibility as well as making the conveyor belt 10 have better extensibility and flexibility.

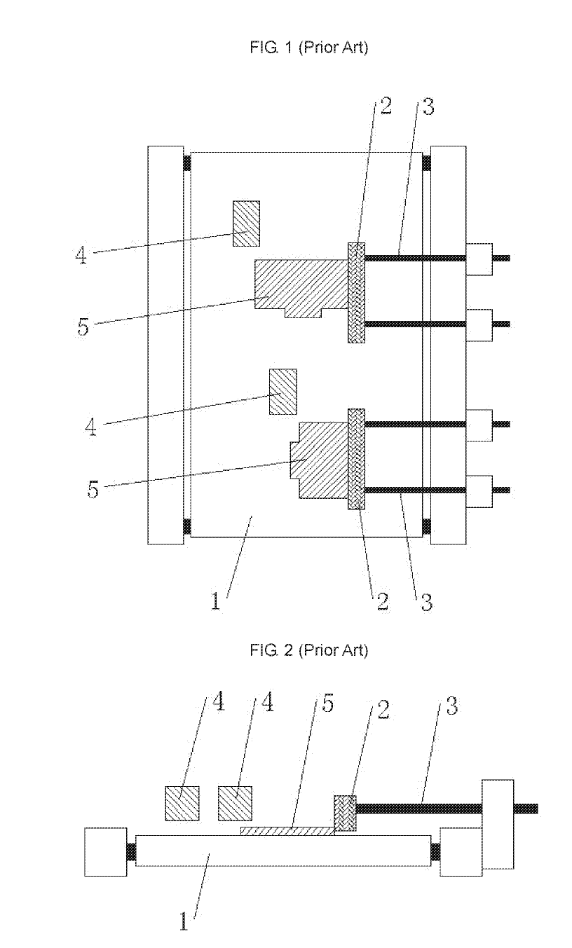

In the light curing device according to the present embodiment, the positioning block 12, which is configured to position an object to be conveyed, is directly provided on a portion of the carrying surface of the conveyor belt 10. In contrast, in the light curing device in the prior art, the positioning baffle 2 is provided above the conveyor belt 1, and is supported by the baffle support 3, as shown in FIG. 2. Compared with the light curing device in the prior art, the light curing device according to the present embodiment has advantages of better positioning effect on an object to be conveyed and simple structure, and more importantly, the positioning block 12 of the light curing device according to the present embodiment will not cause damage to an object to be conveyed, and thus the quality of an object to be conveyed is ensured.

To enable the light curing device according to the present embodiment to be applied to processing objects, such as liquid crystal display panels 5, with different sizes, the light curing device may further include a support unit, and the support unit includes the slide rail 13 and the rail support 14. The rail support 14 is extensible and retractable, and is configured to support the slide rail 13. The slide rail 13 is provided horizontally above the conveyor belt 10 so that a lengthwise direction of the slide rail 13 is perpendicular to the conveying direction of the conveyor belt 10. The light source 11 is provided on the slide rail 13 and is moveable horizontally along the slide rail 13. As a result, the light source 11 can horizontally move in a direction perpendicular to the conveying direction of the conveyor belt 10 on the slide rail 13.

Specifically, the rail support 14 is an extensible and retractable support, a length and/or a height of which are adjustable, and may be provided at two sides of the conveyor belt 10. That is, the rail support 14 supports both ends of the slide rail 13, respectively, and a length and/or a height of the slide rail 13 will change accordingly when a length and/or a height of the rail support 14 are adjusted. Since the light source 11 is provided on the slide rail 13, the light source 11 will move in the vertical direction when a height of the rail support 14 is adjusted.

Alternatively, the rail support 14 may be merely provided at one side of the conveyor belt 10. In this case, the rail support 14 only supports one end of the slide rail 13. Both the rail support 14 and the slide rail 13 are rigid components, thus, the rail support 14 can stably support the slide rail 13.

To enable accurately controlling a position of the light source 11, the slide rail 13 and/or the extensible and retractable rail support 14 may include scale marks, which are configured as a reference for adjusting a position of the light source 11, thereby enabling accurate control of a position of the light source 11. By such configuration, distances by which the light source 11 needs to move horizontally and vertically may be accurately determined according to the size of a liquid crystal display panel 5 conveyed on the conveyor belt 10 and a position of the liquid crystal display panel 5 on which light will irradiates. As a result, the light source 11 may be moved to a desired position directly and accurately, and the accuracy and efficiency of processing are increased.

Further, to prevent the light source 11 from sliding after being moved to a desired position, a fastening knob 15 is provided on the slide rail 13 and is connected to the light source 11. The fastening knob 15 is capable of being tightened so that the light source 11 is fixed to the slide rail 13, and being loosened so that the light source 11 is moveable along the slide rail 13. By such configuration, after the light source 11 is moved to a desired position, the fastening knob 15 may be tightened so that the position of the light source 11 is locked, facilitating subsequent light irradiation on a film layer to make the film layer cured.

In the light curing device provided by the present embodiment, on one hand, a positioning block is provided on a portion of a carrying surface of the conveyor belt and the positioning block includes a positioning surface which is configured to position an object to be conveyed. As a result, the light curing device has a simple structure and a good positioning effect, and avoids the disadvantages due to employing a positioning baffle in the prior art. On the other hand, a light source is provided on the slide rail which is supported by the extensible and retractable rail support, such that the light source can move both horizontally and vertically relative to the conveyor belt. Further, the slide rail and/or the extensible and retractable support include scale marks. As a result, a position of the light source can be controlled conveniently and accurately, enabling the light curing device to deal with objects, such as liquid crystal display panels, with different sizes.

It should be noted that, the positioning surface 120 is described herein by taking a liquid crystal display panel 5, which is taken as an example of an object to be conveyed, as an example, wherein the positioning surface 120 is a plane to closely contact a surface of the liquid crystal display panel 5, thereby enabling positioning of the liquid crystal display panel 5, but the present invention is not limited thereto. A shape of the positioning surface 120 may be designed according to a shape of a surface, which will be in close contact with the positioning surface 120, of an object to be conveyed, such that objects to be conveyed with various shapes may be positioned. For example, in a case where the positioning block 12 includes a plurality of positioning sub-blocks 121, the positions at which the plurality of positioning sub-blocks 121 will be provided may be designed, such that the positioning surface 120 has various shapes. As another example, the plurality of positioning sub-blocks 121 may be configured as moveable components. In this case, the light curing device may further include a positioning sub-block position adjusting unit, which is configured to adjust positions of the positioning sub-blocks on the conveyor belt, so that the positioning surface 120 has various shapes capable of being in close contact with a surface of an object to be conveyed.

It should be understood that, the foregoing embodiments are only exemplary embodiments used for explaining the principle of the present invention, but the present invention is not limited thereto. Various variations and improvements may be made by a person skilled in the art without departing from the spirit and essence of the present invention, and these variations and improvements also fall into the protection scope of the present invention.

What is claimed is:

1. A light curing device, comprising a conveyor belt and a light source provided above the conveyor belt, wherein, a positioning block is provided on at least a portion, which is parallel to a conveying direction of the conveyor belt, of a carrying surface of the conveyor belt, the positioning block includes a positioning surface which is perpendicular to the carrying surface of the conveyor belt and extends along the conveying direction of the conveyor belt, and the positioning surface is configured to position an object to be conveyed.

2. The light curing device according to claim 1, wherein, the positioning block includes a plurality of positioning sub-blocks which are strip-shaped, the plurality of positioning sub-blocks are arranged parallel to each other in the conveying direction of the conveyor belt, and respective side surfaces of the plurality of positioning sub-blocks which face towards a same direction form the positioning surface.

3. The light curing device according to claim 1, wherein, the positioning block is an elongated integral structure extending in the conveying direction of the conveyor belt, and the positioning surface is a side surface of the elongated integral structure.

4. The light curing device according to claim 1, further comprising a support unit including a slide rail and a rail support, wherein, the rail support is configured to support the slide rail, the slide rail is provided horizontally above the conveyor belt so that a lengthwise direction of the slide rail is perpendicular to the conveying direction of the conveyor belt, and the light source is provided on the slide rail and is moveable along the slide rail.

5. The light curing device according to claim 2, further comprising a support unit including a slide rail and a rail support, wherein, the rail support is configured to support the slide rail, the slide rail is provided horizontally above the conveyor belt so that a lengthwise direction of the slide rail is perpendicular to the conveying direction of the conveyor belt, and the light source is provided on the slide rail and is moveable along the slide rail.

6. The light curing device according to claim 3, further comprising a support unit including a slide rail and a rail support, wherein, the rail support is configured to support the slide rail, the slide rail is provided horizontally above the conveyor belt so that a lengthwise direction of the slide rail is perpendicular to the conveying direction of the conveyor belt, and the light source is provided on the slide rail and is moveable along the slide rail.

7. The light curing device according to claim 4, wherein, the rail support is an extensible and retractable support, a length and/or a height of which are adjustable, and is provided at one or two sides of the conveyor belt.

8. The light curing device according to claim 5, wherein, the rail support is an extensible and retractable support, a length and/or a height of which are adjustable, and is provided at one or two sides of the conveyor belt.

9. The light curing device according to claim 6, wherein, the rail support is an extensible and retractable support, a length and/or a height of which are adjustable, and is provided at one or two sides of the conveyor belt.

10. The light curing device according to claim 7, wherein, the slide rail and/or the extensible and retractable support include scale marks, which are configured as a reference for adjusting a position of the light source.

11. The light curing device according to claim 8, wherein, the slide rail and/or the extensible and retractable support include scale marks, which are configured as a reference for adjusting a position of the light source.

12. The light curing device according to claim 9, wherein, the slide rail and/or the extensible and retractable support include scale marks, which are configured as a reference for adjusting a position of the light source.

13. The light curing device according to claim 4, wherein, a fastening knob is provided on the slide rail and is connected to the light source, the fastening knob is capable of being tightened so that the light source is fixed to the slide rail and being loosened so that the light source is moveable along the slide rail.

14. The light curing device according to claim 5, wherein, a fastening knob is provided on the slide rail and is connected to the light source, the fastening knob is capable of being tightened so that the light source is fixed to the slide rail and being loosened so that the light source is moveable along the slide rail.

15. The light curing device according to claim 5, wherein, a fastening knob is provided on the slide rail and is connected to the light source, the fastening knob is capable of being tightened so that the light source is fixed to the slide rail and being loosened so that the light source is moveable along the slide rail.

16. The light curing device according to claim 1, wherein, the light source is an ultraviolet light source.

17. The light curing device according to claim 4, wherein, the light source is capable of moving in a direction perpendicular to the conveying direction of the conveyor belt.

18. The light curing device according to claim 1, wherein, both the conveyor belt and the positioning block are made of an antistatic material.

19. The light curing device according to claim 1, wherein, the positioning surface is a plane and is configured to closely contact a surface of an object to be conveyed.
